(19) United States
(12) Patent Application Publication
(10) Pub. No.: US 2023/0359731 A1
(43) Pub. Date: Nov. 9, 2023

(54) Threat Hunting Across Datacenters To Identify Security Incidents

(71) Applicant: Microsoft Technology Licensing, LLC, Redmond, WA (US)

(72) Inventors: Sekhar Poornananda CHINTALAPATI, Redmond, WA (US); Pieter Kristian BROUWER, Redmond, WA (US); Gaurav Anil YEOLE, Surrey (CA); Virendra VISHWAKARMA, Issaquah, WA (US); Dattatraya Baban RAJPURE, Sammamish, WA (US); Mihai Silviu PEICU, Redmond, WA (US); Vinod Kumar YELAHANKA SRINIVAS, Bellevue, WA (US); Rajesh Raman PEDDIBHOTLA, Sammamish, WA (US)

(21) Appl. No.: 17/739,366

(22) Filed: May 9, 2022

(51) Int. Cl. G06F 21/55

(52) U.S. Cl. CPC G06F 21/554; G06F 2221/034

(57) ABSTRACT

Techniques for generating an identifier index table (IIT) and for executing queries are disclosed. The IIT maps different labels used among different data sources to a commonly defined data type. The IIT is used to generate a set of queries that are executable based on selection of the commonly defined data type and that are executable against the different data sources to search for an indicator of compromise (IOC) within the different data sources. The results from the queries are analyzed in an attempt to identify the IOC.

### BACKGROUND

A “data breach” or “data security incident” refers to a violation in which sensitive data is compromised in some manner. For instance, the data may be accessed by an unauthorized entity; the data may be improperly copied and transmitted; the data may be viewed improperly; and/or the data may be stolen, leaked, or otherwise spilled in some manner. Examples of common data security incidents include, but certainly are not limited to, a scenario where a terminated employee was able to retain access to a resource after his/her termination; a scenario where a vendor account was not deactivated after the vendor was terminated; a scenario where a user's alias was changed; and so on.

When a data security incident occurs, it is the policy of many organizations to conduct what is referred to as a “data security incident investigation,” which is conducted by a “security analyst” or an “investigator.” Unfortunately, it is often the case that investigators are trying to find a needle in a haystack, and it has traditionally been the case that a significant number of manual steps were involved in the investigative process. For instance, traditionally, the investigator would need to individually obtain access to multiple “clusters” or “data sources.” Then, the investigators would start the investigation based on a hunch as to where or how the incident likely occurred.

Data security incident investigations typically start with an indicator of compromise (IOC). An IOC is a piece of forensic evidence that indicates whether a potential intrusion on a host system has occurred.

Typical IOCs are an Internet Protocol (IP) address, a username, or a certificate or token. The goal of an investigator is to put together the entire story (i.e. the “blast radius”) surrounding this IOC to tell what actually happened with regard to the incident. Because of the nature of attack scenarios, an attacker could compromise an IP, then pivot and obtain access to a certificate. The attacker may then use that certificate for other malicious activities. Thus, the next steps an attacker can take grows exponentially, and an investigation can go in multiple directions from the starting point (i.e. the IOC), and the breadth and scope of an investigation can involve hundreds of data sources, components, and/or services.

Based on that initial hunch, the investigators would conduct any number of searches in an attempt to find the IOC and footprints of the attacker away from that initial IOC to other areas in the network or system. To investigate, the analysts/investigators typically identify the data sources they would first like to investigate based on the IOC. Once the security analysts discover the different data sources, they contact the owners of those data sources to obtain access for the investigation.

The investigators would then analyze the output from the initial result set to look for additional clues. The investigators would then repeat the search and analysis steps until they can figure out what occurred. In some cases, the investigators might miss a relevant cluster/data source, thereby leading to an incomplete analysis.

After getting access to each of the clusters/data sources, the investigators typically build a series of queries or searches for execution against those data sources. Because of the myriad of schemas in which services log activities, the investigators often had to search audit logs, operational logs, inventory logs, property tables (e.g., like HeadTrax), and anomaly tables using individually customized queries. These tables can be distributed through hundreds, thousands, or even tens of thousands of databases (i.e. clusters or data sources). Once the investigators get results from these data sources, the investigators put together correlations of what happened in a consumable format. Generating these correlations across so many different data sources is a highly difficult process.

The above processes are typically repeated multiple times in a single investigation, thus increasing the time to mitigate an incident. Also, in an organization, investigator churn can happen. Thus, when a new investigator is brought on to the project, it was often the case that the new investigator would have to start from scratch or at least from a dated version of the investigation.

As evidenced above, traditional investigative processes were quite laborious and intensive. It is highly desirable to improve these investigative processes. For instance, it would be beneficial to provide a centralized way to discover data sources to conduct the investigation. It would also be beneficial to provide secure and gated time-bound access to the data sources for the investigation. It would also be beneficially to enable new investigators to be able to leverage and build on the learnings from existing investigations.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to systems, devices, and methods for generating an identifier index table (IIT) that maps different labels used among different data sources to a commonly defined data type and for using the IIT to generate a set of queries that are executable based on selection of the commonly defined data type and that are executable against the different data sources to search for an indicator of compromise (IOC) within the different data sources.

Some embodiments identify a plurality of data sources. At least some of these data sources label a common type of data differently such that a plurality of different labeling schemas are present among the data sources The embodiments detect the different labeling schemas from among the data sources. The process of detecting includes detecting which labels are used by each data source to label each data source's corresponding data. The embodiments compile, from among the data sources, a group of labels that are determined to commonly represent a same type of data despite at least some of the labels in the group being formatted differently relative to one another. The embodiments also generate an IIT that maps the labels in the group to a commonly defined data type. As a consequence, despite at least some of the labels in the group being formatted differently relative to one another, the labels in the group are now all extrinsically linked with one another as a result of the labels in the group all being mapped to the commonly defined data type. The embodiments also generate a set of queries that are selectably executable against the data sources. The set of queries are configured to obtain data that is labeled in accordance with the identified labels. The set of queries are executable in response to selection of the commonly defined data type included in the IIT.

Some embodiments receive query results that are generated as a result of the set of queries being executed against the data sources. The embodiments analyze the query results to identify a network of relationships linking a user to a particular IOC. Here, the user is a suspected attacker against one or more of the data sources. Based on the identified network of relationships linking the user to the particular IOC, the embodiments trigger generation of a new set of queries for execution against the data sources. The new set of queries are designed in an attempt to identify additional points of contact the user had with regard to the data sources. The embodiments analyze new query results that are generated as a result of the new set of queries being executed against the plurality of data sources. In this manner, the embodiments are able to track the forensic “footprints” of the attacker through the data sources. In doing so, the embodiments can help mitigate the impact of the attack and can help potentially prevent future attacks.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of a searching phase of a session used to attempt to identify points of contact an attacker may have had on a system comprising data sources.

FIG. 2 illustrates different examples of data sources.

FIG. 3 illustrates how different labels can be used by different data sources to represent the same type of data.

FIG. 4 illustrates an example of searching a specific data source.

FIG. 5 illustrates an example of an analysis phase of the session.

FIG. 6 illustrates an example of a user interface displaying various time-based correlations between data.

FIG. 7 illustrates another example of a user interface displaying various time-based correlations.

FIG. 8 illustrates how the disclosed service can perform various pivot operations to generate a network of relationships.

FIG. 9 illustrates an example user interface for establishing a new session.

FIG. 10 illustrates an example user interface designed to receive parameters (e.g., a time range) to limit the scope of a search.

FIG. 11 illustrates how a previously saved session can be resumed.

FIG. 12 illustrates an example user interface designed to enable an analyst to select different scenario types.

FIG. 13 illustrates an example user interface showing various actors.

FIG. 14 illustrates an example user interface showing various actors.

FIG. 15 illustrates an example user interface showing various access events.

FIG. 16 illustrates an example user interface showing various activities.

FIG. 17 illustrates an example user interface showing various anomalies.

FIG. 18 illustrates an example user interface showing various entities.

FIG. 19 illustrates an example user interface showing various entity relationships.

FIG. 20 illustrates a flowchart of an example method for performing a search phase of a session.

FIG. 21 illustrates an identifier index table (IIT).

FIG. 22 illustrates a flowchart of an example method for performing an analysis phase of a session.

FIG. 23 illustrates an example computer system that can be configured to perform any of the disclosed operations.

### DETAILED DESCRIPTION

Embodiments disclosed herein relate to systems, devices, and methods for generating an identifier index table (IIT) that maps different labels used among different data sources to a commonly defined data type and for using the IIT to generate a set of queries that are executable based on selection of the commonly defined data type and that are executable against the different data sources to search for an indicator of compromise (IOC) within the different data sources.

Some embodiments identify a plurality of data sources. At least some of these data sources label a common type of data differently such that a plurality of different labeling schemas are present among the data sources The embodiments detect the different labeling schemas from among the data sources. The process of detecting includes detecting which labels are used by each data source to label each data source's corresponding data. The embodiments compile, from among the data sources, a group of labels that are determined to commonly represent a same type of data despite at least some of the labels in the group being formatted differently relative to one another. The embodiments also generate an IIT that maps the labels in the group to a commonly defined data type. As a consequence, despite at least some of the labels in the group being formatted differently relative to one another, the labels in the group are now all extrinsically linked with one another as a result of the labels in the group all being mapped to the commonly defined data type. The embodiments also generate a set of queries that are selectably executable against the data sources. The set of queries are configured to obtain data that is labeled in accordance with the identified labels. The set of queries are executable in response to selection of the commonly defined data type included in the IIT.

Some embodiments receive query results that are generated as a result of the set of queries being executed against the data sources. The embodiments analyze the query results to identify a network of relationships linking a user to a particular IOC. Here, the user is a suspected attacker against one or more of the data sources. Based on the identified network of relationships linking the user to the particular IOC, the embodiments trigger generation of a new set of queries for execution against the data sources. The new set of queries are designed in an attempt to identify additional points of contact the user had with regard to the data sources. The embodiments analyze new query results that are generated as a result of the new set of queries being executed against the plurality of data sources. In this manner, the embodiments are able to track the forensic “footprints” of the attacker through the data sources. In doing so, the embodiments can help mitigate the impact of the attack and can help potentially prevent future attacks.

This disclosure document is outlined in the following manner. First, various benefits, improvements, and practical applications of the disclosed embodiments will be presented at a high level. Next, a discussion on a so-called “session” will be provided. The disclosed embodiments are focused on the use of a “Security Analysis Service” (or simply a “service”) that can facilitate the session. Initially, the session includes a number of searches (based on queries), so the discussion will initially discuss how the service (i.e. the Security Analysis Service) is able to conduct a search. Various illustrations are provided to show how the clusters or data sources can be configured and some of the challenges the service solves with regard to querying those different clusters. After an initial search is performed, the results of that search are analyzed, as will be described in a so-called analysis workflow. In conjunction with the discussion surrounding the analysis workflow, this disclosure will also present various user interfaces that are designed to assist the analyst or investigator in processing the data. The analyst can trigger additional searches in an attempt to acquire more information in order to try to follow the digital footprints of an attacker. In some cases, a leg of a search might not be fruitful, so the service allows for a backtracking option. This document also includes various methods that can be performed to facilitate the disclosed embodiments. Following the discussion of the methods, this documents describes the workings of a computer system that can be configured to perform any of the disclosed operations.

### Examples of Technical Benefits, Improvements, and Practical Applications

The following section outlines some example improvements and practical applications provided by the disclosed embodiments. It will be appreciated, however, that these are just examples only and that the embodiments are not limited to only these improvements.

As mentioned previously, there are numerous pressure points with regard to traditional investigative processes. These pressure points include difficulties with regard to generating searches and queries. These pressure points further include reliance on the hunch or intuition of an investigator. The pressure points further include difficulties with regard to analyzing the data, such as by identifying relationships between different data points (e.g., how is a certificate associated with an IP address and how is that IP address associated with a particular username, etc.).

More particularly, traditionally, there has not been a single library of queries (which are used to facilitate the investigation to find an IOC and footprints of an attacker) that can be used for threat investigation. Various pockets of tribal knowledge were available in the form of different investigators maintaining different query sets. To execute those queries, however, investigators were tasked with obtaining different sets of permissions against the target data sources.

In contrast with traditional techniques, the disclosed embodiments beneficially democratize the so-called “tribal” knowledge by building a single threat investigation library that can be leveraged by all security investigators through the disclosed service (i.e. the Security Analysis Service or “SAS”). Building this library enables individual analysts and investigators to leverage the expertise of other investigators, thereby enhancing the investigative routine. As another benefit, the embodiments enable users (aka analysts or investigators) to choose specific threat hunting scenarios in the provided user experience (UX). Additionally, the embodiments beneficially allow for the onboarding of new investigation scenarios through the UX.

As another benefit, the embodiments provide an investigation library that can encapsulate the tribal knowledge in a reusable format for all investigations. By following the disclosed principles, it is now possible to consider each data source (e.g., cluster, database, table, etc.) as a separate distinct entity and to create an identifier index table for specific identifiers a security analyst may be interested in when conducting a search. Each security investigation can now be modelled as a “session” that can contain any number of search and analysis requests. In response to each request, the service can query a set of data sources, ingest the results into a target database (aka a results database), analyze the results, and then present the results of the analysis. New and improved queries can be generated based on feedback provided by the analyst. These new queries can then be used to gather additional data, which may then be analyzed in an attempt to find the footprints of the attacker.

Because of the inbuilt ability of the disclosed service to extract “entities” from search results and the ability to perform any number of requests, it is possible to start from a single IOC and to build the full story around the blast radius of the attacker's initial point of entry (or around a footprint of the attacker). As used herein, an “entity” is an item of interest to a security investigator. An entity can be an IOC, or it can be related to an IOC. An entity can have a type and can have several synonymous representations that are equivalent from an investigation point of view. An entity can be a logical item of interest or perhaps even a physical item of interest. An entity can have a friendly name or can have a representation that is not friendly. As more entity types are added to the service, the number of relationships that can be extracted from the results increases, and those results can then be used to calculate the blast radius associated with an incident.

Beneficially, the disclosed service uses a set of tools to simplify, extend, and enrich the investigative search results. These tools are extensible and configurable. As a result, the analysis can be tailored to the requirements of a use case or service. New capabilities can be added by request or by contributing source code.

Accordingly, the disclosed embodiments bring about numerous benefits to the technical field of security incident investigation. These benefits include, but are not limited to, a reduced time to detect (TTD) an incident as well as a reduced time to mitigate (TTM) an incident for investigations, where the reduction can be from days (traditionally) to a mere few hours or less. The benefits further include a reduction of engineering toil for analysts, an abstraction of data sources, and an automation of commonly used security and forensics analysis workflows. These and numerous other benefits will now be discussed in detail throughout the remaining portions of this disclosure.

### Conducting a Search in a Session

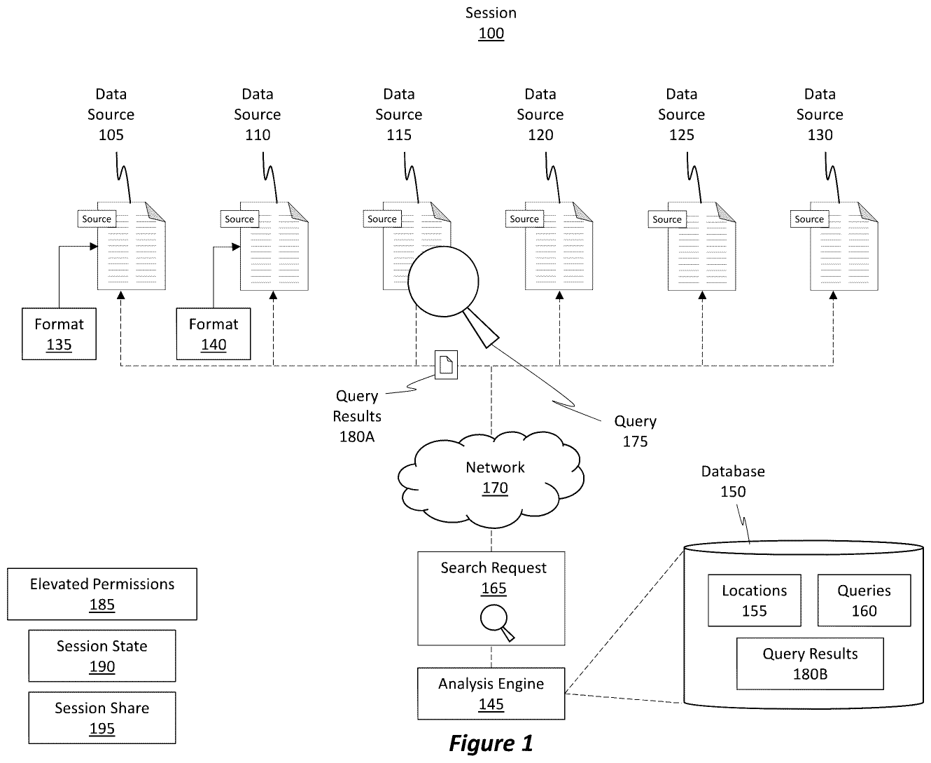

Attention will now be directed to FIG. 1, which illustrates an example of a session 100 in which a search to identify an IOC and footprints of an attacker are implemented. As used herein, the session 100 is used to track the lifetime of an investigation. The disclosed service (i.e. the Security Analysis Service) facilitates the operations of a session. Notably, the service can be a local service operating on a local host or, alternatively, the service can be a cloud service operating in a cloud environment.

The session 100 can include any number of different searches, which are facilitated by the service. It is the goal of a session to identify how an attacker infiltrated a particular system (e.g., a cluster, data source, data center, or any number of data sources) as well as to identify where the attacker went within the system (i.e. to follow the digital or forensic footprints of the attacker).

Each session is associated with a database in the backend. A “one database per investigation/session” model helps with isolation between sessions. The disclosed service can provision a database for the investigator as well as inject analysis functions into the database. That is, the service can pre-provision databases to ensure that the databases are ready to go for an investigator on-demand, thus reducing the latency and improving the user experience. As the number of pre-provisioned databases depletes with an increasing number of investigations, the service can create new pre-provisioned databases. A session can also be created, opened, purged, shared, and/or saved.

The investigative process typically includes a searching process. Results of the search are then compiled and analyzed by the analyst. Based on that initial analysis, the analyst may trigger the generation and execution of additional searches in an attempt to better locate the attacker's footprints. This search-then-analyze routine can be repeated any number of times. Accordingly, FIGS. 1, 2, 3, and 4 generally describe a searching process.

FIG. 1 shows a high level description for a searching investigative process. FIG. 1 will be used to introduce the searching techniques at a high level. After the initial introduction, a deep dive into the searching techniques will be provided via a subsequent discussion.

FIG. 1 shows a number of data sources (aka “clusters”), such as data sources 105, 110, 115, 120, 125, and 130. Although only six data sources are shown, one will appreciate how any number of data sources can be examined during the session 100. Indeed, hundreds, thousands, or even tens of thousands of data sources can be searched to identify where an attacker infiltrated the system and where the attacker subsequently went within the system. As mentioned previously, use of the term “system” in this context can refer to a particular cluster or data source or to any number of data sources, such as perhaps within a data center or an enterprise or cloud network.

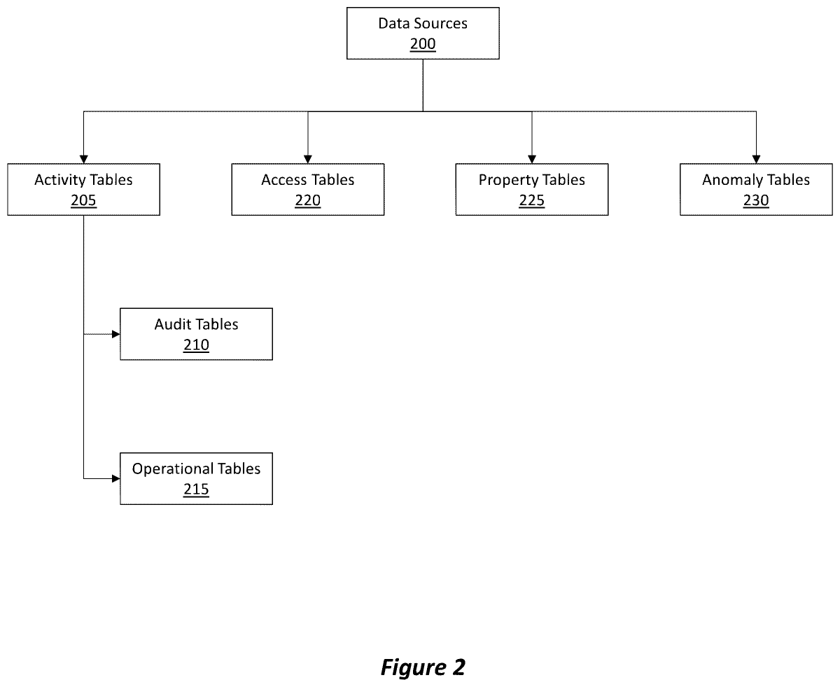

The data sources can be files, folders, databases, or any other repository of information. It is often the case that the data sources have different formats. For instance, data source 105 has a first format 135 while data source 110 has a second, different format 140. The format generally refers to how data is organized and/or how data is labeled. FIG. 2 shows various example data sources 200.

In some cases, the data sources 200 can include activity tables 205, such as audit tables 210 and operational tables 215. The data sources 200 can further include access tables 220, property tables 225, and anomaly tables 230. As a brief introduction, activity tables 205 are tables that track activity or operations and typically contain information about what is happening in a system. There are typically two types of activity tables, namely: audit tables 210, which capture privileged events happening within the system, and operational/tracing tables 215, which capture information regarding the operations that are deemed relevant. Access tables 220 indicate which entities have accessed the system. The property tables 225 (aka inventory tables) are tables that store information regarding the actors or assets within an organization. The anomaly tables 230 indicate errors or anomalies that may have occurred with regard to the system. Any other type of table, database, or compilation of information can be considered as a data source. Despite the formats of these data sources being different, the service is able to map the schemas of the various tables in order to represent activity within the system.

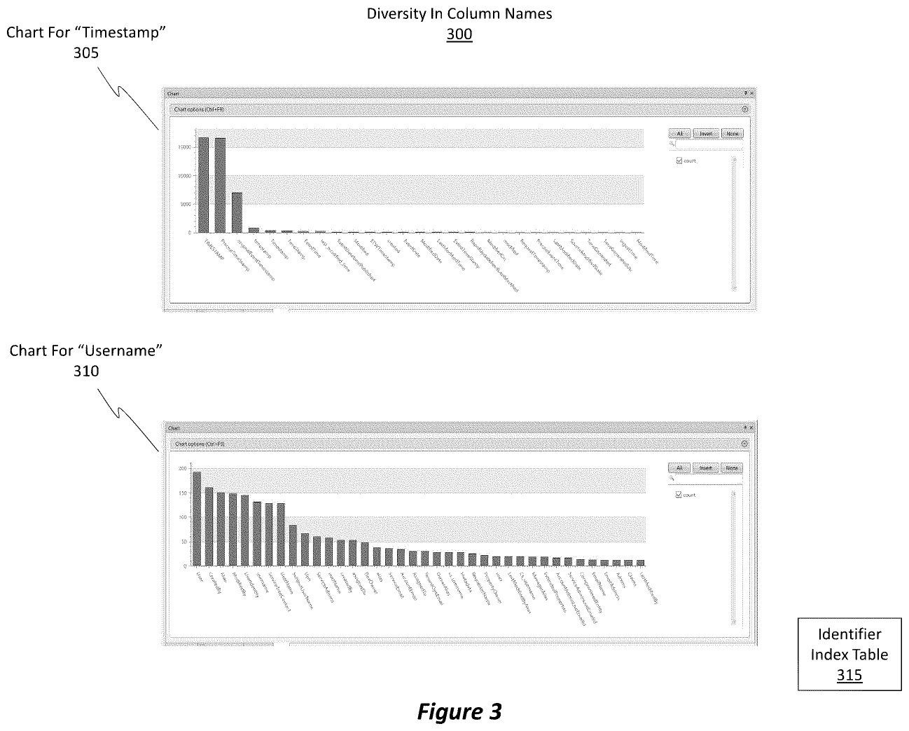

That is, the different data sources might be formatted in different ways. FIG. 3 provides some illustrative information regarding these differences in format.

FIG. 3 shows how different labels can be used for a common set of data. For instance, FIG. 3 shows the diversity in column names 300 for a set of data sources. The top chart 305 is a chart illustrating terms related to “timestamp.” To illustrate, many data sources use the term “TIMESTAMP.” Other data sources, however, use the term “PreciseTimeStamp.” Still others use “originalEventTimestamp,” “timestamp,” “Timestamp,” “TimeStamp,” “EventTime,” and so on. All of these terms generally refer to the same type of data even though the different data sources are using different terms.

The chart 310 is a chart illustrating how different data sources refer to “username.” For instance, many data sources use the term “User.” Other data sources use terms such as “CreatedBy,” “Alias,” “ModifiedBy,” “UserIdentity,” and so on. From these two charts, one can see how diverse the column names and other labels might be in a set of data sources.

The differences in these labeling techniques has traditionally been a serious pressure point in the investigative process. The disclosed service, however, is designed to generate a so-called identifier index table 315 that can map and link the various different labels for the various different units of data. The service is further able to automatically generate queries that are tailored to operate on the widely varying data sources using this identifier index table 315.

To generate the identifier index table 315, the service ingests the schemas for all of the data sources that are being searched and analyzed in the specific domain being targeted for investigation. This is performed because of the diversity of schemas across data sources. A security investigator is searching for identifiers like time, IP address, usernames, certificate thumbprints, and so on. As shown in FIG. 3, it is often the case that these common identifiers are logged under hundreds of different column names in the data sources.

In this situation, the service can abstract out the exact semantics of an identifier “type.” Based on that abstracted type, the service builds the identified index table 315. This table can then be used to query across systems in different domains. In particular, the identifier index table 315 includes a type heading and then mappings between the various different labels that fall under that type.

As an example, the identifier index table 315 may include a “timestamp” type. All of the labels illustrated in chart 305 can then be mapped under the common “timestamp” type. When a search is subsequently performed, the service can consult this identifier index table 315 to generate customized queries that are applicable to each specific data source. For instance, a first query may be applicable to a first data source, where the first data source uses the label “TIMESTAMP,” so the first query uses that same parameter. Similarly, a second query may be applicable to a second data source, where the second data source uses the label “PreciseTimeStamp,” so the second query uses that particular parameter.

Based on the schema analysis performed by the service on the data sources, the following conclusions can be made, even in a diverse logging environment. Specifically, it is possible to: (i) abstract out identifiers that are of interest in searching across all the systems into the identifier index table (IIT) 315, where the IIT 315 is a representation of reusable knowledge of where different identifiers are logged across all the tables and (ii) use domain knowledge to augment the IIT 315 for any missing information or long tail idiosyncrasies.

The service can build the IIT 315 offline for an entire domain prior to the commencement of a session. The IIT 315 can then be used to build queries based on an identifier type, which can be selected by an investigator at the beginning of a search in order to attempt to find the footprints of an attacker.

Beneficially, a set of pre-built queries can be generated and be ready to execute based on what the security analyst wants to search for. That is, the queries can also be generated by the service offline and before a session begins. These queries can be organized based on the defined “types” that are included in the IIT 315. As an example, suppose there are 1,500 different data sources and further suppose there are 750 different labels for the common “timestamp” type. The service is able to generate at least 750 different queries for execution in order to fully cover all of the variations for the timestamp type in the 1,500 different data sources.

The IIT 315 can be further augmented by analyzing the results from user searches and continuously added to in order to include any new or missing columns. The IIT 315 can be leveraged in multiple ways to generate queries as well as when conducting the analysis, as will be described in more detail to follow. Other identifier index tables can be built for other identifier types, such as IP address, thumbprint, and so on.

Another advantage of creating an index for each identifier (i.e. for creating the IIT 315) is that it enables the service to do “Field Scoped” searches/queries, thus limiting the number of columns that are being queried in a target data source. These field scoped, time-bound queries can help ensure that a large load is not being placed on the remote data sources and that the query execution time is optimal.

Returning to FIG. 1, the service includes a so-called analysis engine 145. This analysis engine 145 has access to a database 150 where the locations 155 of the data sources 105-130 are maintained.

The analysis engine 145 also has access to a set of queries 160 that are automatically generated and perhaps modified, where these queries 160 are executable against the data sources 105-130 to obtain information with regard to attacks. The queries 160 are pre-built and are ready to execute on demand. As mentioned previously, the queries 160 can be built using the IIT 315 of FIG. 3.

To complete the configuration of the queries 160 for a particular search, all that is needed (in some cases) is the input from the security analyst on which user or identifier to search for. As soon as this input is available, the service can enqueue any number of the pre-built queries for execution, thus saving the analyst significant amounts of time.

A session 100 includes one or more search requests, such as search request 165. A request (aka search request) is used to represent a search operation done as part of the hunting/investigative activity. In some cases, a request can be associated with an identifier type (e.g., username, IP address, etc.) and a timeframe.

Each request triggers the execution of multiple queries across multiple data sources/clusters. As mentioned previously, the service is able to build and generate queries in an offline mode for both an initial search process and for any subsequent search process (e.g., one that may be triggered based on the results of an analysis). The service is further able to leverage this pre-built intelligence in an online mode to get results and to analyze them quickly.

The service executes the set of built-in queries based on an identifier type against the source clusters (i.e. the data sources). The results are then ingested for analysis into various target or results databases.

Accordingly, the search request 165 is a request to obtain information from the data sources 105-130 in an attempt to identify the blast radius and impact of an attack. The analysis engine 145 receives parameters of the search request 165 (e.g., what type of information to search for) and then selects queries to execute against the data sources 105-130. The analysis engine 145 transmits the queries over a network 170 to the data sources 105-130 for execution against those data sources. For instance, the query 175 is shown as being executed against the data source 115. The query results 180A are received and stored in the database 150, as shown by the query results 180B. In addition to analysis, one of the reasons the query results 180B are ingested or stored is to support archival scenarios for security incident related investigations in the future.

The analysis engine 145 is provided with elevated permissions 185 so that the analysis engine 145 can execute the queries against the data sources 105-130. In some cases, there are single investigators with persistent access to a large number of data sources. Over time, each investigator who wants to perform an investigation will go through a particular process to obtain access to the underlying data sources. The persistent access granted to the investigators themselves could be an attack vector. The disclosed service has adopted a just in time (JIT) elevated security group (ESG) model. JIT ESG refers to an elevated security group for accessing data sources. This model is provided to ensure that the access is JIT approval based and the access to the source clusters needs to be renewed on JIT expiry.

The workflow for getting access (i.e. the elevated permissions 185) is as follows. The user/analyst becomes a part of the JIT ESG to get JIT based access. Data source owners provide access to users in the JIT ESG for security analysis. In some cases, no persistent access to services or users is enabled. Users accessing the disclosed service are also part of JIT ESG. The service queries the target data sources on behalf of the user/analyst. Session isolation results of each investigation session are stored in a separate database, thus ensuring separation of investigations. Some investigations may not be shareable with all investigators. Separate databases and sessions help with eliminating information leaks.

The results of the search are stored in a results database, such as the database 150. The user has access to this results database. The data itself can be purged as soon the investigation session is complete. In some implementations, data is retained for only 48 hours, though other time periods can be used. In this manner, elevated permissions 185 can be implemented in order to facilitate the searching process.

The session 100 also includes a session state 190 that can be saved. An investigator can save and persist the session state 190. An investigator can open the session state 190 at a later point in time in order to further perform the investigation or, alternatively, a different investigator can open the session state 190 and continue where the session 100 was left off. Additionally, the session 100 can be shared, as shown by session share 195, with other investigators.

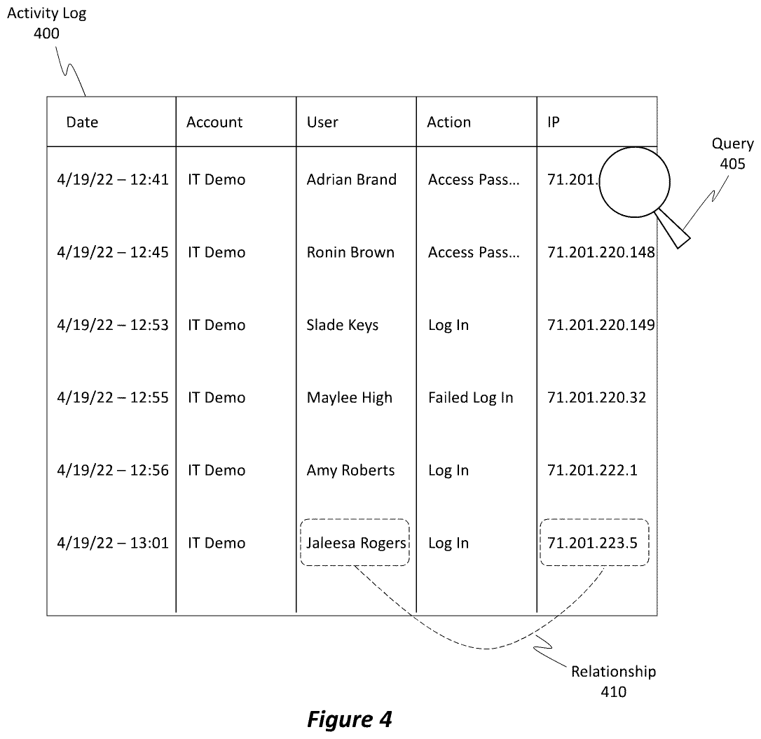

One purpose of executing queries is to attempt to identify where an attacker entered the system and where that attacker subsequently went within the system. To do so, the queries can search for various pieces of information within a data source. The embodiments can then analyze the query results to identify relationships and other points of interest. FIG. 4 shows an example of some information that can be queried.

FIG. 4 shows an activity log 400, which is an example of a data source/cluster. A query 405 is being executed against the activity log 400 to identify information of interest. In this example scenario, the query 405 is searching the IP label in the activity log 400. Recall, the service previously analyzes the schemas of the data sources and grouped or correlated related labels with one another. In this particular scenario, the label “IP” may be categorized or grouped under a type called “IP Address.” The IIT 315 of FIG. 3 can record and map the IP label under the IP address type. The query 405, which may be a pre-built query, was then generated for this particular data source and was formatted in accordance with the detected schema of that data source. When an analyst first configured a search request, the analyst may have selected the “IP Address” type to search. Using the IIT 315, the service was able to pre-build a query to search the IP column for this particular data source and discover information for the IP Address type.

In some cases, the query 405 may be configured to return multiple pieces of information, such as perhaps the IP addresses as well as the usernames of users who accessed the system. As will be described in more detail later, during the analysis phase of the session 100 of FIG. 1, the service can establish a relationship 410 that links a particular user with a particular IP address.

In a different data source, the IP address may reappear. Because the system has linked the user's name with the IP address, the system can then identify that the user also accessed that different data source as well. In this regard, the service can make correlations and links in data to identify which users (or potential attackers) accessed which data and to then identify where the attackers traversed through the system.

Returning to FIG. 1, the load on the data sources is typically not something that is controllable by the service. The variables under control of the service, however, are the distribution strategy around the order of execution for the queries and minimizing the load on the service itself by making sure that there is valid data to ingest and by ingesting and creating tables when it is beneficial to do so. With that in mind, the service can implement a few different strategies for query distribution by enabling a query prioritization approach that takes into account various factors.

One factor is that queries that are most likely to yield results can be distributed early or before other queries. This is achieved through a prioritization scheme (e.g., 1-10, with 1 being the highest priority). Another factor is that queries against multiple tables of a data source can be distributed evenly to avoid throttling at the data source. Another factor is that only queries yielding non-zero row counts in the results can be ingested in the target cluster (i.e. the query results 180B stored in the database 150 aka the “results database”), thus avoiding unnecessary table creation requests on the target cluster/results database.

Having a pre-determined prioritization scheme helps with having a repeatable distribution and execution sequence and thus leads to more reliability of execution. It is also the case that the number of concurrent users/analysts can influence the number of queries being executed by the service and is thus monitored for throttling purposes.

Pre-provisioned databases (i.e. results databases) that have been injected with analysis functions are available for the investigator when he/she starts an investigation. Thus, an investigator can rely on the fact that both the current set of analysis functions as well as the results data are available at a future date if needed. The query results 180A can be injected into proxy tables (e.g., the pre-provisioned results databases) that closely mirror the schema of the data sources with some new fields added for tracking purposes. Accordingly, as the results of the queries are received, the service can then analyze those results. Thus, this disclosure will now turn to focus on the analysis of the query results.

### Analysis Workflow

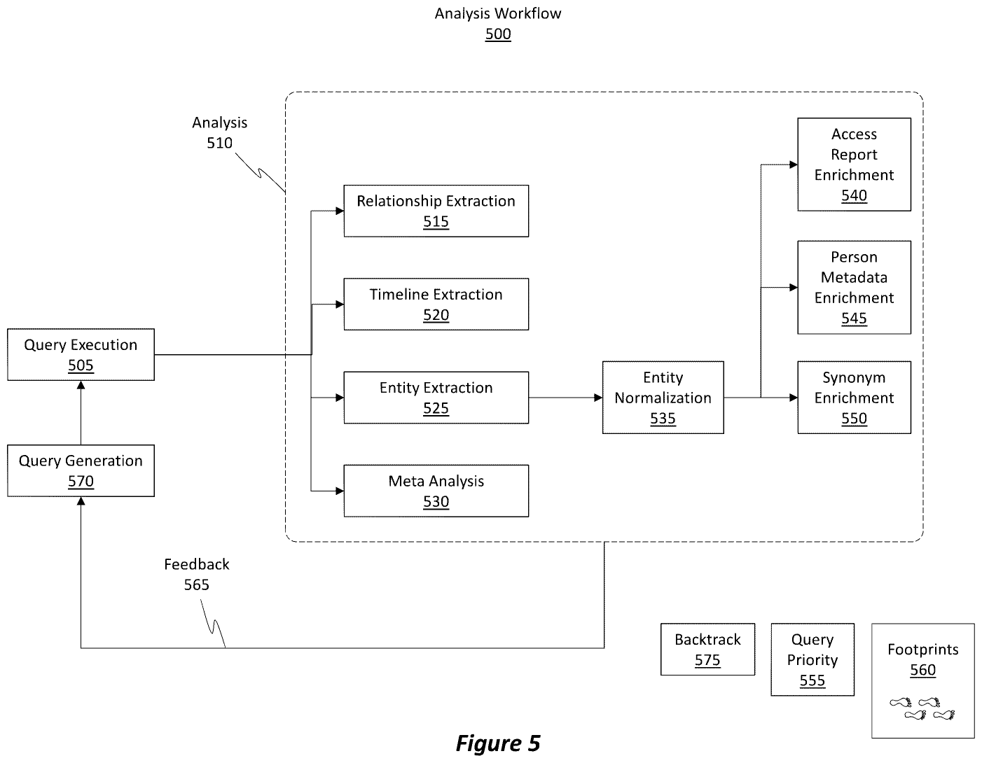

Attention will now be directed to FIG. 5, which illustrates an analysis workflow 500 that can be triggered after a set of queries are executed, as represented by the query execution 505. Specifically, the analysis 510 can be performed when the results of the queries are received, and the analysis 510 can be performed by the disclosed service.

The analysis 510 includes a number of operations which will be introduced and then later discussed in more detail. To illustrate, the analysis 510 includes a relationship extraction 515, a timeline extraction 520, an entity extraction 525, and a meta analysis 530. Each of these operations can optionally include a number of sub-operations. For instance, the entity extraction 525 is shown as including an entity normalization 535, which can optionally include an access report enrichment 540, a person metadata enrichment 545, and a synonym enrichment 550.

The analysis 510 is performed on the results of the queries in order to determine where and how an attacker infiltrated the system. The analysis 510 can additionally trigger the generation of new queries in order to gather additional data from the data sources. In some instances, as discussed previously, queries can be given different priorities, as shown by query priority 555.

Since the queries run against remote clusters under different loads, a request may get throttled on the remote cluster. The service can retry every throttled query with exponential back-off against the target cluster. As soon as results start being ingested into a results database, the results can be auto-analyzed through an inline analysis mechanism. The goal of the analysis is to provide the analyst with enough analysis to take the analyst to the last mile with minimal toil. Accordingly, it is the goal of the queries and the analysis to find the attacker's digital footprints 560 throughout the system.

The analysis 510 can also generate feedback 565, which can be used to generate new queries, as shown by query generation 570. These new queries can be targeted queries focused on trying to find some additional and perhaps more specific information related to the attack.

Returning to FIG. 5, the service is able to extract relationships between different units of data, as represented by the relationship extraction 515. Building the identifier index table 315 of FIG. 3 as part of schema analysis is highly beneficial for the results analysis. Indeed, the same identifier index table 315 can also be used to extract relationships between the entities.

As an example, imagine an IP search being performed as part of the investigation. It may be the case that 1,300 queries have been executed against the source clusters and a subset of them yielded non-zero results. However, since the schema of the source tables is preserved in the results database, the embodiments can leverage the same identifier index table 315 to extract usernames involved, certificates involved, and so on from the search results because the service knows where these identifiers are stored in the source tables.

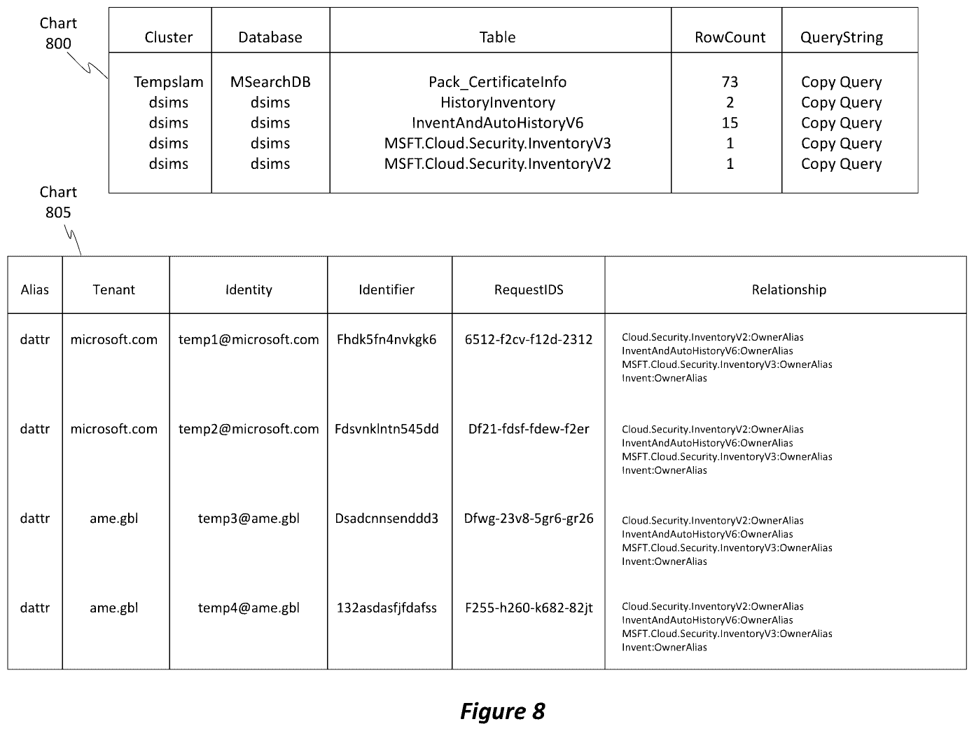

Using this approach, numerous benefits can be achieved. For instance, the service can pivot from an identified certificate to an associated user and from that user to that user's point of access to the system. For instance, FIG. 8 shows two charts, namely, chart 800 and chart 805. Chart 800 shows the results that are generated based on searching for a certificate. Chart 805 shows the results from using that certificate to pivot in order to identify the owner of the certificate. That information can then be used to identify points of contact a user has with the system.

As the number of identifier types increases, the number of different relationship types among them will increase, and the service will be able to extract more relationships from the data using the above approach. These new identifiers can then be used to search again and the analysis process will continue.

Returning to FIG. 5, as another example, the relationship extraction 515 aspect of the service can generate a report of relationships between entities. Two entities are said to have a relationship if they appear in the same row of a table. The disclosed service can use this capability to allow analysts to drill into the query results. For example, on a user interface, an analyst can see a summary count of how many relationships there are between different types of entities. Clicking on a count populates a table showing those relationships in detail. This table can use a standard schema that reports on relationships found in any source tables, regardless of the schema of those tables. The detailed relationships view can be used to answer questions like “which IP addresses did this user access?” or “how is this IP address connected to this subscription ID?”

The relationship extraction 515 capability can be used to answer different questions in other use cases. For instance, the service can generate tables that track requestor/approver IDs in different contexts (e.g., JIT access, pull requests, etc.). The service can flag any cases where a user approved his/her own request. The service can also look for user-to-user relationships in those tables and mark any rows where the same user identifier is seen on both sides of the relationship.

Since time is like an instruction pointer in a distributed system, time-based correlations across the results database can be achieved using the timeline extraction 520 part of the analysis 510. That is, in some cases, a timeline schema can be defined to map all the results into a specific timeline.

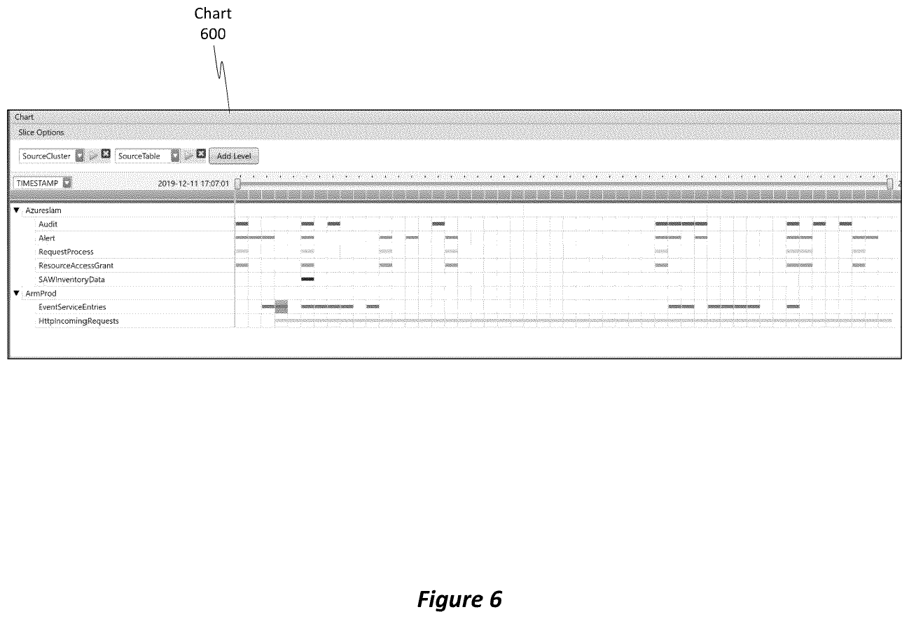

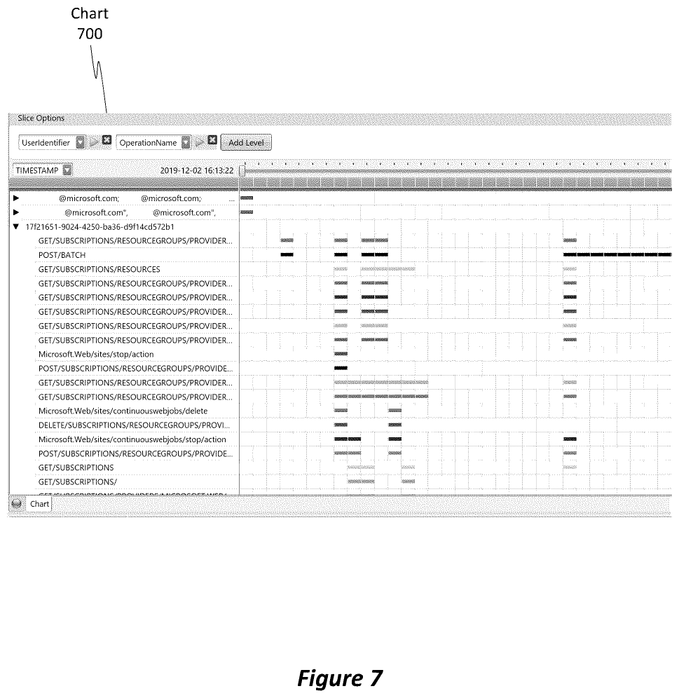

To illustrate the benefits of the timeline extraction 520, FIG. 6 shows a chart 600 that portrays the activity performed across multiple data sources in a easy to view “timeline” format pivoted by certain chart parameters (e.g., “SourceCluster” and “SourceTable”). Clicking on any of the individual cells provides the data associated with the action. In this case, one can clearly see that just in time (JIT) access is being requested before the user performs activity in ARMProd. Another view of timeline analysis is shown in FIG. 7 by the chart 700, which is pivoted by the chart parameters “UserIdentifier” and “OperationName.” Accordingly, to facilitate the analysis, various time-based charts can optionally be generated and displayed for an analyst to view and interact with via the timeline extraction 520.

Further, the timeline extraction 520 can optionally provide a configurable timeline that helps an analyst zoom into a particular domain or zoom out. Similarly, if the analyst just wants to view the audit activity across the system without operational activity, the service enables the analyst to filter the data in order to just see that activity. This kind of aggregated universal timeline approach combined with targeted domain based timelines is highly beneficial.

Entity extraction 525 scans query results and generates a report of every entity found. The report includes the CDTC (cluster/database/table/column) where each entity was found, its type (user identifier, activity id, etc.), and value. This capability currently supports numerous different types of entities and is designed to be highly extensible. Examples of some supported entity types are: user, subscriptionid, activityid, ip, correlationid, principalpuid, applicationid, thumbprint, resourceid, detectionid, and icmid.

With entity normalization 535, user entities are stored in a variety of formats, such as nicknames, complete email addresses, globally unique identifier (GUID), etc. Entity normalization 535 maps those values to a common name. For example, when a remote table records the user identifier as a principal object identifier (01D), this feature finds the nickname for that GUID. This output can be combined with that of other analysis functions to replace the raw value with the nickname in their output (e.g., the raw value is retained in case no nickname can be found). This improves the readability of the results without hiding information that may be important to an investigation. Other types of entities can be normalized as well.

The service can provide data enrichment for entities found in the results. For example, for user entities, the service can obtain the personnel data, user access reports, and alternate identifiers. Each type of enrichment can be individually toggled in the analysis workflow configuration. The enrichment works by mapping the identifiers against tables and stored functions.

The enrichment can be extended by defining new mappings. For example, if a table of malicious IP addresses was available, the service can use that to query if any of the IP addresses found in the results were malicious. This feature can be extended to use other sources, such as REST APIs provided by other services. In this manner, the service can provide access reports detailing how users accessed the system (e.g., as shown by the access report enrichment 540) and can provide detailed information regarding users and their actions (e.g., as shown by the person metadata enrichment 545).

It is often the case that entities being searched for will have synonymous representations, thereby making the search process tedious. As such, it is desirable to configure queries to account for all “synonyms” for an entity. The synonym enrichment 550 of FIG. 5 provides this option. Accordingly, synonyms for entities can be determined, and then a normalization process can be performed on those terms for a particular entity.

In one scenario, the output of one analysis service can be combined with the output of another analysis service to provide enhanced information. For instance, the relationship extraction 515 capability of the service can be used to combine a result with the output of the entity normalization 535 capability, which maps alternate identifiers for a user into a common nickname. The expected result would be that the same value appears for the normalized user identifiers on both sides of the relationship, and the service can flag any rows where that was not the case.

The analysis workflow 500 can further include a backtrack 575 option. Backtracking allows an analyst to analyze each request separately or in combination with any number of other requests. Backtracking also allows an analyst to hide results that he/she did not find useful. In some embodiments, search results can be stored in a Kusto database, which is not meant to support arbitrary deletion of data. A single request may cause the service to ingest data into hundreds of tables, making it difficult to quickly backtrack the request while the analyst is interacting with the user interface. To address such issues, the embodiments create a master function in the session database that maintains a list of backtracked requests. When a new table is created in the database, the service can create a filter function that references the new table and the master function. The filter can be applied to the table by setting a row-level-security policy in Kusto.

When a user backtracks a request, the master function can be updated. This effectively applies the change across hundreds of tables in <10 ms. As a result, the analyst can easily backtrack when a search leg was determined to not be fruitful.

By way of additional clarification, backtracking is defined as a capability for an analyst to “undo” a search request. This is a usability feature, not a security requirement, so the goal is to hide the results of the backtracked request from the analyst, not to permanently delete those results.

To facilitate this backtrack feature, the embodiments add a new API to backtrack one or more requests, where the inputs are the session ID and the request ID. An API to undo the backtrack is also provided, where that API will allow the analyst to see the results of his/her requests once more. This is faster and more efficient than asking the analyst to redo any requests the analyst previously backtracked if he/she needs to see the results again.

### Example User Interfaces

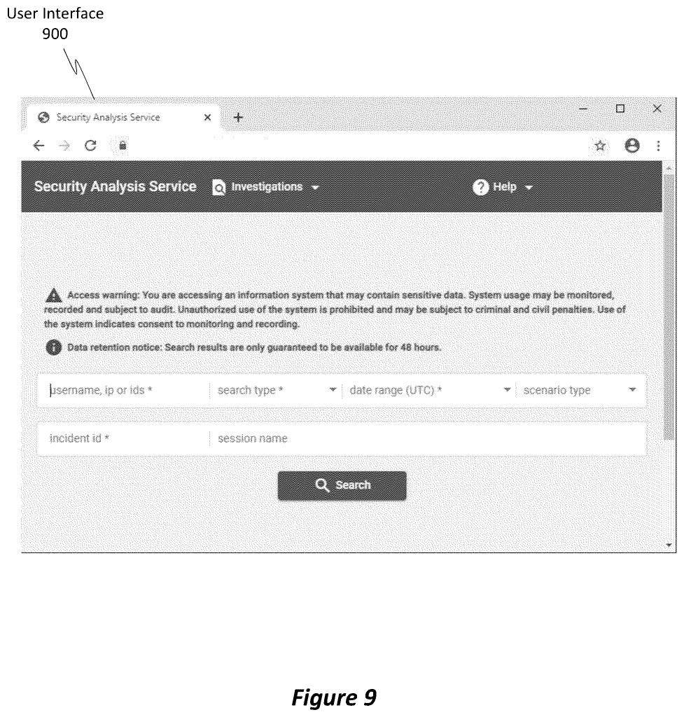

Having just described various aspects of the analysis workflow, attention will now be directed to FIGS. 9 through 19, which illustrate various example user interfaces that can be presented during the analysis workflow to help facilitate the analysis. One will appreciate how these user interfaces are provided for example purposes only, and their exact layout or content should not be considered as binding in any manner.

FIG. 9 shows an example user interface 900 for an identifier based search. The analyst can start a session by filling in the requested information in the user interface 900. Each session can be associated with multiple requests, and each request can be auto-analyzed. Thus, the analyst can come to the portal with a single identifier to search for and will go away with valuable analysis information.

The user interface 900 includes the following fields: an Incident Id, a Username, ip or ids (i.e. the actual entity being searched for), a Search type (specifying the type of entity being searched for), a Date range (covering the time of interest to investigate the specified entity), a Scenario type (this is an option to select pre-built queries in support of custom scenarios), a Session name (to add a meaningful name to a session).

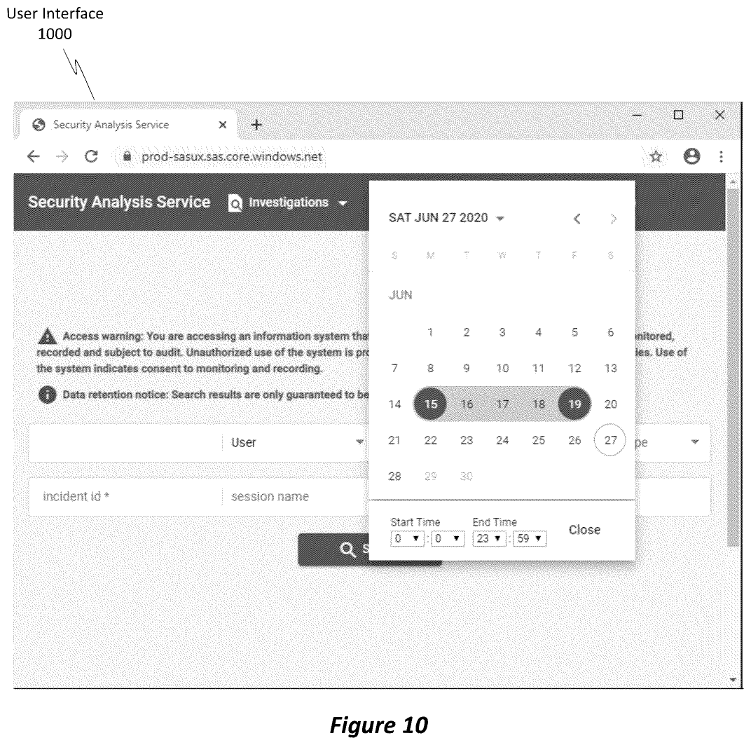

FIG. 10 shows a user interface 1000 where the user can select a desired date range over which to search the data clusters/sources. Searching over a defined time period can help reduce the large amounts of data that might otherwise be returned.

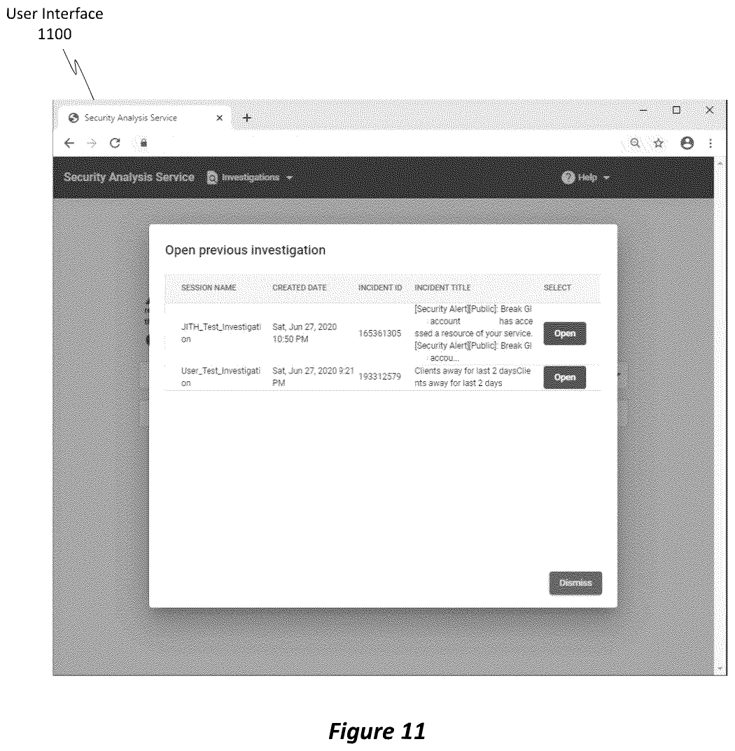

FIG. 11 shows a user interface 1100 illustrating the ability to run a hunting scenario (i.e. an investigation) that was onboarded previously and can be re-run by any analyst. For example, as mentioned previously, a session's state can be saved (or shared) and can be loaded at any time.

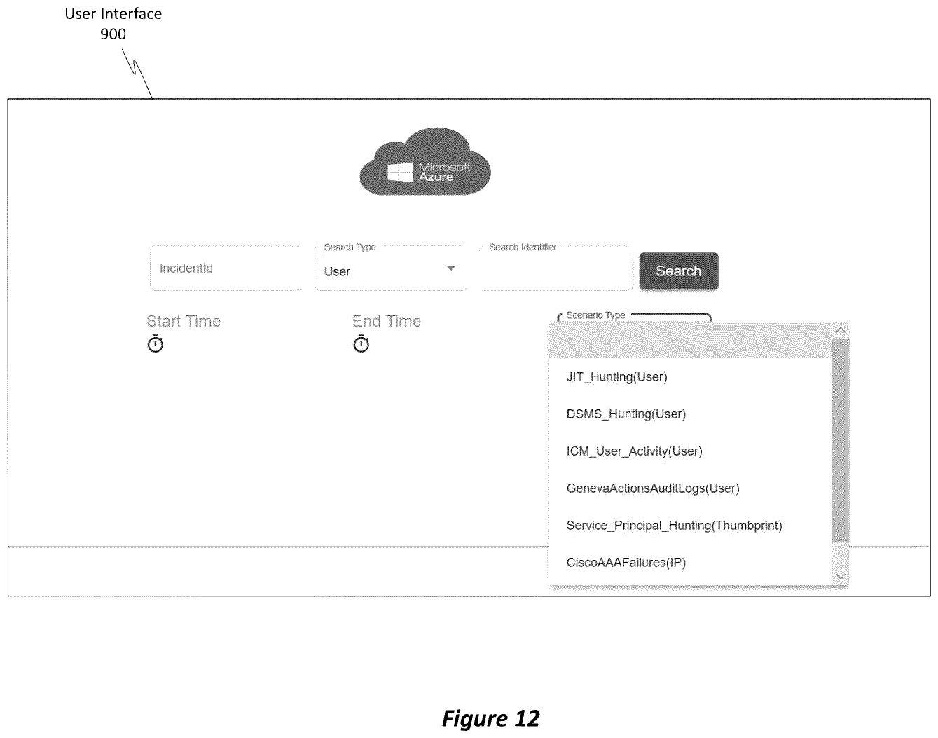

FIG. 12 shows some of the different hunting scenarios (i.e. investigations) that can optionally be performed. For instance, the analyst can enter a search scenario type that he/she would like to initiate. Once a first search of a session is triggered, the service creates a new results database for the investigation and opens the analyst workspace for the analyst.

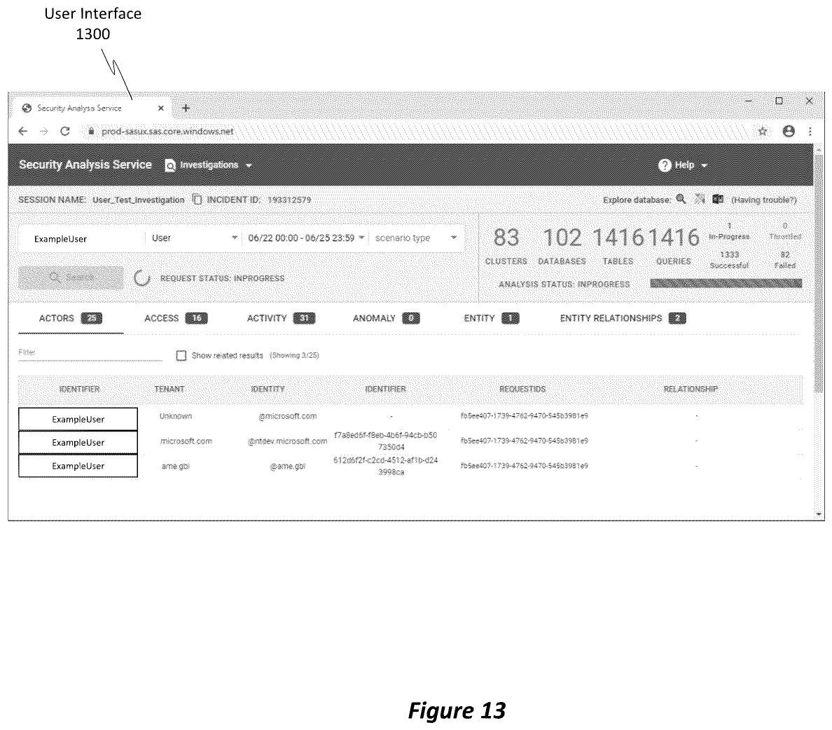

FIG. 13 shows an example user interface 1300 comprising a data analysis section, which is a space where the search results can be displayed and analyzed. This section is also organized into multiple tabs to facilitate easy, efficient access to the type of data targeted for the investigation. For instance, the tabs include an Actors Tab, an Access Tab, an Activity Tab, an Anomaly Tab, an Entity Tab, and an Entity Relationships Tab.

The Actors Tab contains detailed information regarding “WHO.” It is typically the case that an analyst would want to first look at the Actors Tab to see the list of actors and their identifiers associated with each domain. This tab currently shows the people involved in the activity the analyst searched for. For example, if the analyst searched for ‘alias1’, the results would return that person's AME*, GME*, AD domains as well as the tenants and other identifiers used to represent that user in the system.

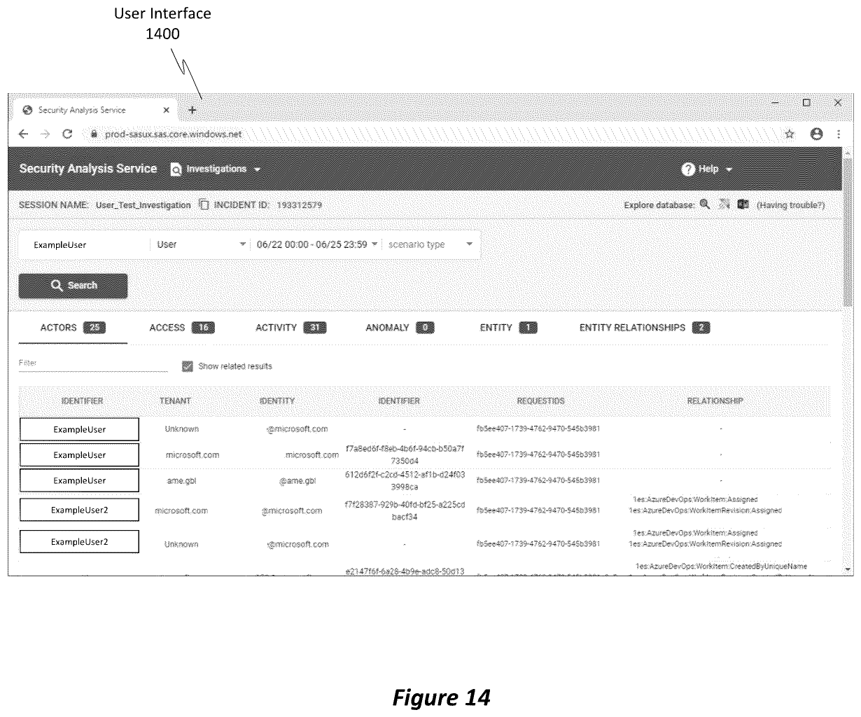

In addition, user interface 1300 can be used to check the “Show related results” checkbox to see accounts that interacted with the search identifier during the timeframe that was searched for and the relationship. For example, it can show users interacting with the same ADO items or participating on the same code review. If the analyst searched for a particular thumbprint, the user interface 1300 will show the owner of that certificate. The relationship column will show why additional users have popped up in the results of the search. In this particular example, the format of the relationship column is Cluster:Database: Table: ColumnName where the related user was found. FIG. 14 is showing another user interface 1400 illustrating the Actors Tab.

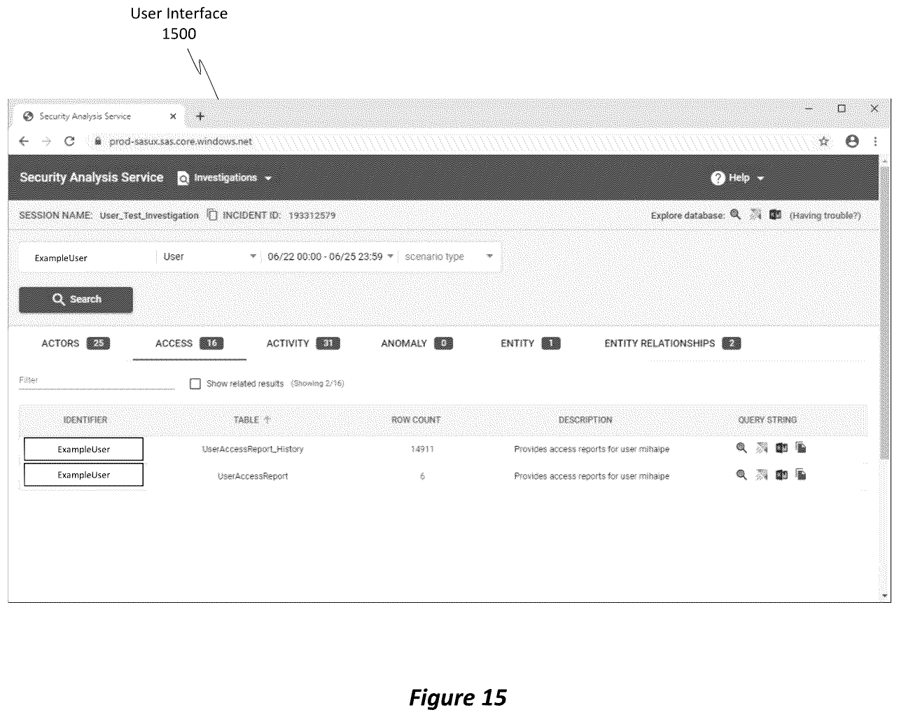

User interface 1500 of FIG. 15 is showing the Access Tab. Currently, the Access Tab is showing the access that has been obtained by a particular user based using dsts on the UserAccessReport.

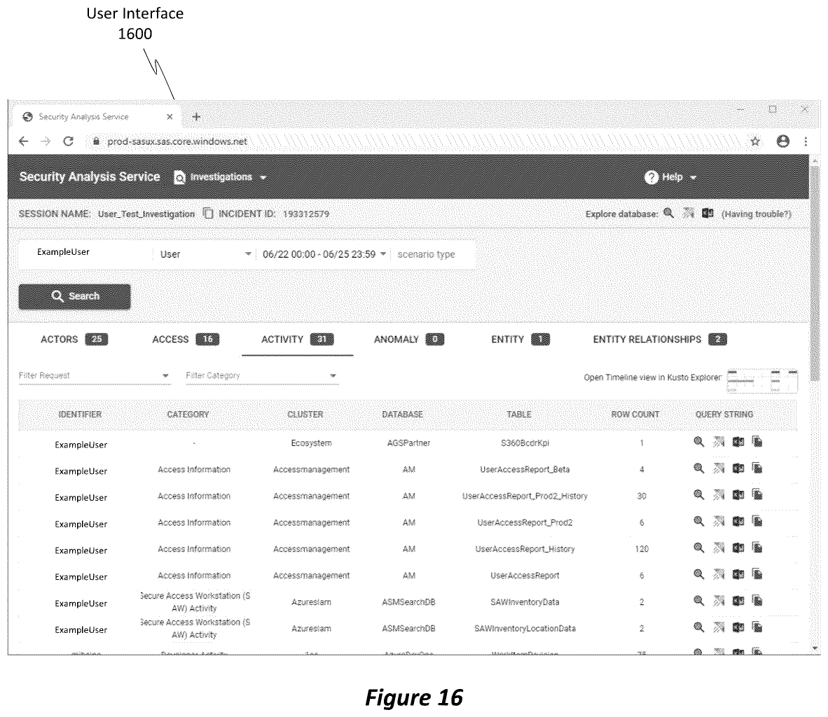

User Interface 1600 of FIG. 16 is showing the Activity Tab. On the Activity Tab, the service displays the actual activity that has been performed by the user (i.e. the suspected attacker) during the timeframe that was selected. The activity can be populated as soon as the search results start arriving. This information can be used to form a map of the user's activity.

The service can use the information in the Activity Tab to bring up a graphical view of the user's activity and to provide different visualizations and pivots. Each results database can come with a library of analysis functions that help in debugging an activity. The service enables the selection of any number of slice options to slice and dice an activity, which will help in organizing the data in a visual format. Clicking on any cell will show the details of the activity performed by the user in that cluster/data source.

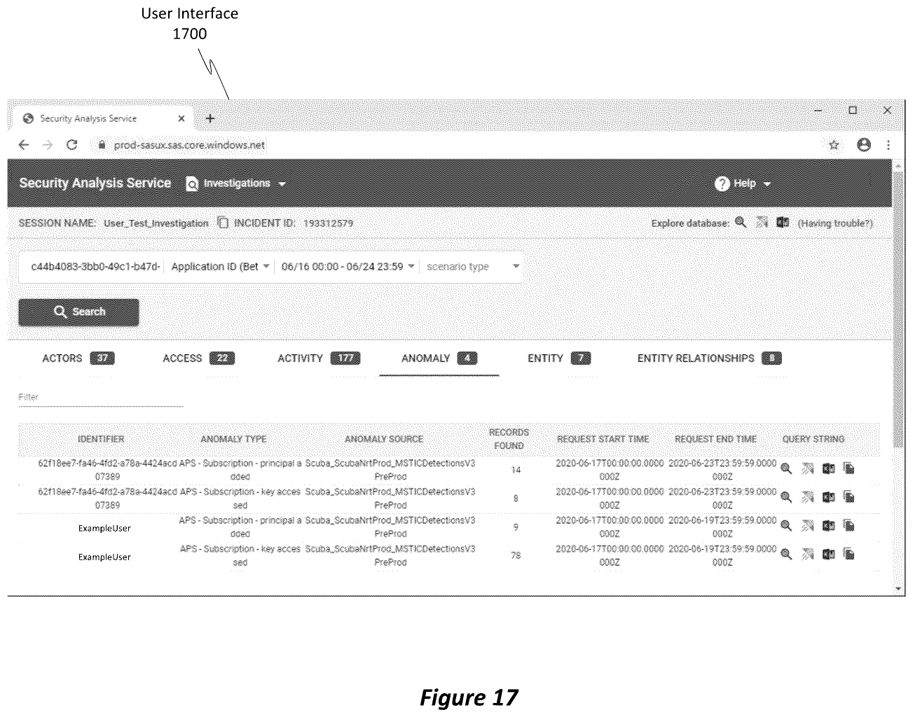

FIG. 17 shows a user interface 1700 that is displaying the Anomaly Tab. The Anomaly Tab displays the automatically uncovered anomalies based on the entered search entries.

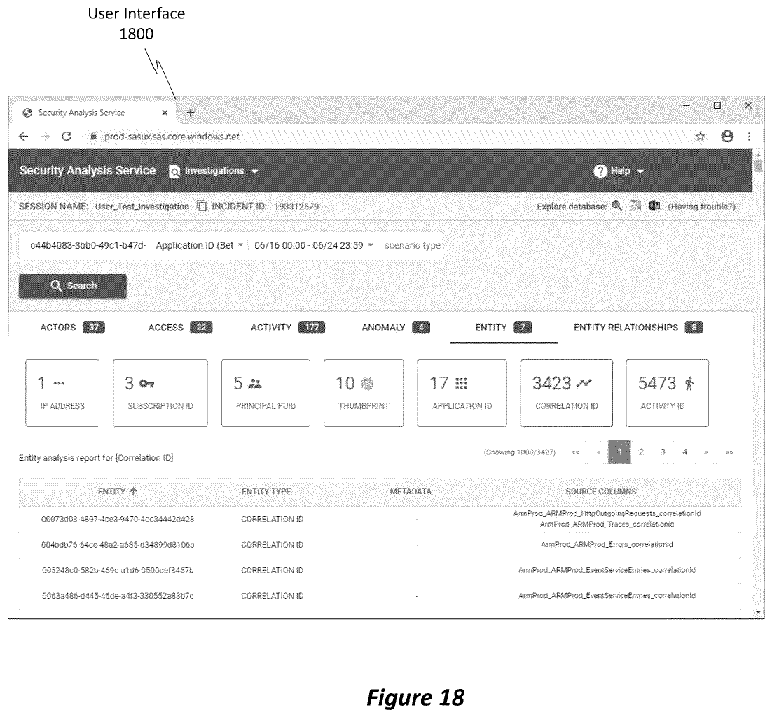

FIG. 18 shows a user interface 1800 that is displaying the Entity Tab. The Entity Tab provides a simple, clean view of high level row counts for each of the entity types existing within the data results of the investigation.

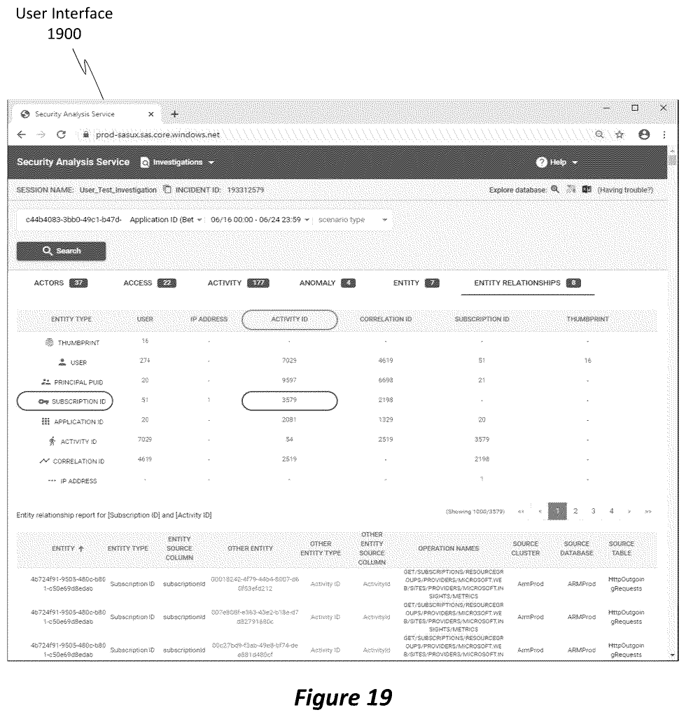

The Entity Relationships Tab, which is shown in the user interface 1900 of FIG. 19, enables the analyst to see a grid of relationships' counts. This tab also allows the analyst to click on any of them to display the details at the bottom.

The disclosed service can generate a report of where a particular search identifier was found and, for each location, whether that location was included in the other analysis functions. This can be used to alert an analyst when the search identifier is embedded in a URI, JSON object, or other data structure that would require additional processing before it can be used by the extraction analysis.

These results are used to improve search queries and entity/relationship extraction functions. This feature can also alert when a column does not consistently contain one type of entity. This helps to filter out spurious entities (e.g., -, (null), etc.) instead of reporting those as errors (Could not find a nickname for user “-”). It also helps to add special handling for columns that contain multiple entity types.

Entity and relationship extraction often depends on the service's knowledge of remote cluster schemas to generate queries that extract information from tables in those clusters. The configuration that generates these queries is periodically updated, both manually and through using the Meta-analysis output. Accordingly, the disclosed service provides numerous different user interfaces to facilitate the analysis workflow mentioned earlier.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

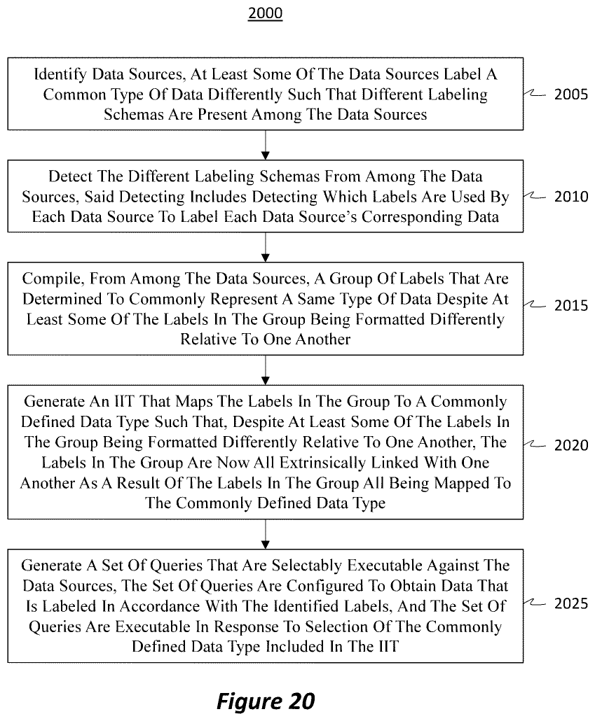

Attention will now be directed to FIG. 20, which illustrates a flowchart of an example method 2000 for generating an identifier index table (IIT) that maps different labels used among different data sources to a commonly defined data type and for using the IIT to generate a set of queries that are executable based on selection of the commonly defined data type and that are executable against the different data sources to search for an indicator of compromise (IOC) within the different data sources. The IOC can be any type of indicator. Examples include, but certainly are not limited to, one of a username, an IP address, or a certificate.

Method 2000 generally represents the searching phase of the session 100 of FIG. 1. Method 2000 can be implemented by the disclosed service.

Method 2000 includes an act (act 2005) of identifying a plurality of data sources. For instance, the data sources 105-130 may be identified. The data sources can include one or more of a database, a file, a folder, or any other data set. At least some of these data sources label a common type of data differently. As a result, a plurality of different labeling schemas are present among the data sources. For instance, FIG. 3 showed the diversity in column names 300, such as by how many different labeling techniques could be used to represent a timestamp.

Act 2010 includes detecting the plurality of different labeling schemas from among the plurality of data sources. The process of detecting includes detecting which labels are used by each data source in the plurality of data sources to label each data source's corresponding data. With reference to FIG. 3, the service can detect all the different techniques for labeling or referencing a timestamp. Some data sources use one label structure to reference a timestamp while other data sources use a different label structure to reference a timestamp. Of course, the examples with regard to “timestamp” are for illustrative purposes only and should not be considered as binding or limiting in any manner.

Act 2015 includes compiling, from among the data sources, a group of labels that are determined to commonly represent a same type of data despite at least some of the labels in the group being formatted/structured differently relative to one another. The term “formatted” can include differences in spelling, structure, or visualization of a body of text. The labels included in the chart 305 can be considered as a group of labels that commonly represent the same type of data (i.e. a timestamp) despite the structure of those labels being different.

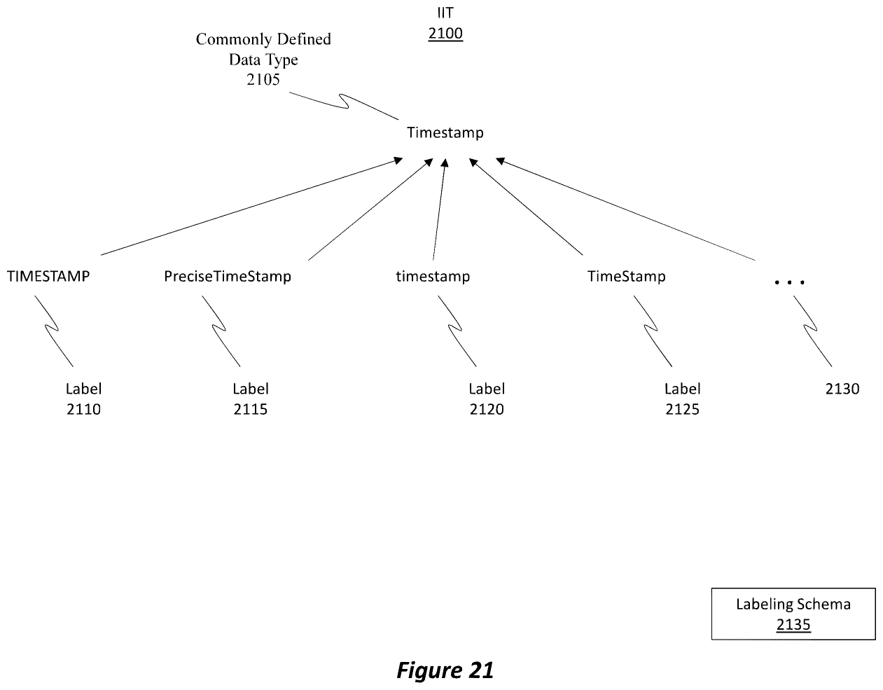

Act 2020 includes generating an IIT that maps the labels in the group to a commonly defined data type. As a result, despite at least some of the labels in the group being formatted differently relative to one another, the labels in the group are now all extrinsically linked with one another as a result of the labels in the group all being mapped to the commonly defined data type. FIG. 21 is illustrative.

FIG. 21 shows an IIT 2100, which is representative of the IITs mentioned thus far.

The IIT 2100 includes a commonly defined data type 2105 (e.g., “Timestamp”). A number of other labels, which are formatted or structured differently, are extrinsically linked to the commonly defined data type 2105 by now being included in the IIT 2100. For instance, the labels 2110, 2115, 2120, and 2125 are linked to the commonly defined data type 2105. The ellipsis 2130 shows how any number of labels can additionally be linked as well. In this regard, the service is able to identify any number of different labeling schemas, as shown by labeling schema 2135, and link the labels together to a common data type.

The IIT 2100 can include any number of different commonly defined data types. For instance, the service can compile, from among the data sources, a second group of labels that are determined to commonly represent a second same type of data. The service can cause the IIT to map the labels in the second group to a second commonly defined data type. In this manner, the IIT can be modified to include additional mappings between additional commonly defined data types and other groupings of labels.

Returning to FIG. 20, act 2025 includes generating a set of queries that are selectably executable against the data sources. For instance, the queries 160 can be generated in the manner discussed previously. The set of queries are configured to obtain data that is labeled in accordance with the identified labels, and the set of queries are executable in response to selection of the commonly defined data type included in the IIT. In some implementations, in response to the commonly defined data type being selected, the service can trigger the execution of the set of queries against the data sources. Optionally, the set of queries can be executed with enhanced permissions to access the data sources. In some cases, the queries are pre-built queries, meaning they are generated in an offline mode even before a session is initiated. Optionally, different execution priorities can be given to queries in the set, such that some of the queries are executed at different times. Results from queries that yield non-zero row counts can be ingested for analysis while results from queries that yield zero row counts might not be ingested.

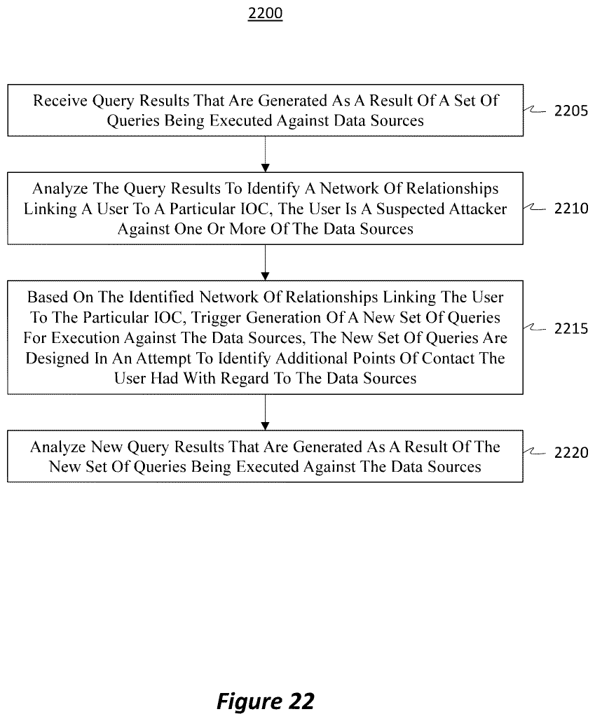

FIG. 22 shows a flowchart for an example method 2200 for analyzing results obtained from executing the set of queries against the plurality of data sources in an attempt to identify an indicator of compromise (IOC). Method 2200 can also be performed by the disclosed service.

Act 2205 includes receiving query results that are generated as a result of the set of queries being executed against the plurality of data sources. For instance, the query results 180A can be received by the service and stored in a results database, as shown by the query results 180B in FIG. 1.

Act 2210 includes analyzing the query results to identify a network of relationships linking a user to a particular IOC. Here, the user is a suspected attacker against one or more of the data sources. For instance, the relationship 410 of FIG. 4 can be identified between various pieces of data. A string or network of relationships can be identified in order to eventually link a particular user to a particular IOC.

Based on the identified network of relationships linking the user to the particular IOC, act 2215 includes triggering the generation of a new set of queries for execution against the data sources. The new set of queries are designed in an attempt to identify additional points of contact the user had with regard to the data sources. For instance, the feedback 565 from FIG. 5 can be used to generate new queries, as shown by the query generation 570.

Act 2220 includes analyzing new query results that are generated as a result of the new set of queries being executed against the data sources. This process can repeat any number of times in an attempt to identify the blast radius of an attacker against the data sources.

Accordingly, the disclosed embodiments provide numerous benefits and advantages in the technical field of security analysis. The embodiments help improve the user's experience as well as significantly reduce the amount of time used to follow the forensic footsteps of an attacker.

### Example Computer/Computer Systems

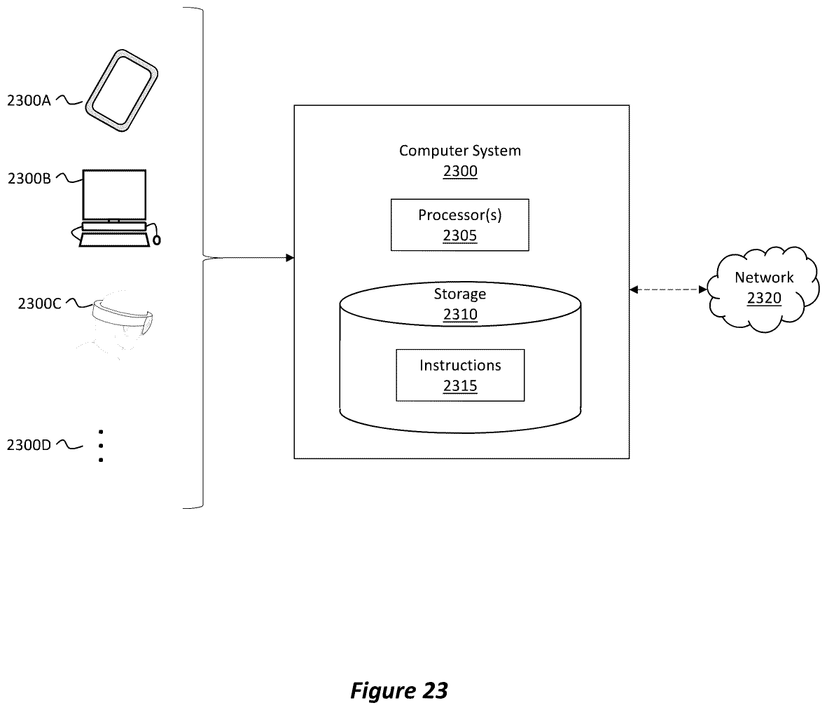

Attention will now be directed to FIG. 23 which illustrates an example computer system 2300 that may include and/or be used to perform any of the operations described herein. That is, computer system 2300 can implement the disclosed service. Computer system 2300 may take various different forms. For example, computer system 2300 may be embodied as a tablet 2300A, a desktop or a laptop 2300B, a wearable device 2300C, a mobile device, or any other standalone device as represented by the ellipsis 2300D. Computer system 2300 may also be a distributed system that includes one or more connected computing components/devices that are in communication with computer system 2300.

In its most basic configuration, computer system 2300 includes various different components. FIG. 23 shows that computer system 2300 includes one or more processor(s) 2305 (aka a “hardware processing unit”) and storage 2310.

Regarding the processor(s) 2305, it will be appreciated that the functionality described herein can be performed, at least in part, by one or more hardware logic components (e.g., the processor(s) 2305). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “engine,” or “service” can refer to hardware processing units or to software objects, routines, or methods that may be executed on computer system 2300. The different components, modules, engines, and services described herein may be implemented as objects or processors that execute on computer system 2300 (e.g. as separate threads).

Storage 2310 may be physical system memory, which may be volatile, non-volatile, or some combination of the two. The term “memory” may also be used herein to refer to non-volatile mass storage such as physical storage media. If computer system 2300 is distributed, the processing, memory, and/or storage capability may be distributed as well.

Storage 2310 is shown as including executable instructions 2315. The executable instructions 2315 represent instructions that are executable by the processor(s) 2305 of computer system 2300 to perform the disclosed operations, such as those described in the various methods.

The disclosed embodiments may comprise or utilize a special-purpose or general-purpose computer including computer hardware, such as, for example, one or more processors (such as processor(s) 2305) and system memory (such as storage 2310), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RANI, ROM, EEPROM, CD-ROM, solid state drives (“SSD”) that are based on RANI, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 2300 may also be connected (via a wired or wireless connection) to external sensors (e.g., one or more remote cameras) or devices via a network 2320. For example, computer system 2300 can communicate with any number devices or cloud services to obtain or process data. In some cases, network 2320 may itself be a cloud network. Furthermore, computer system 2300 may also be connected through one or more wired or wireless networks to remote/separate computer systems(s) that are configured to perform any of the processing described with regard to computer system 2300.

A “network,” like network 2320, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 2300 will include one or more communication channels that are used to communicate with the network 2320.

Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RANI and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating an identifier index table (IIT) that maps different labels used among different data sources to a commonly defined data type and for using the IIT to generate a set of queries that are executable based on selection of the commonly defined data type and that are executable against the different data sources to search for an indicator of compromise (IOC) within said different data sources, said method comprising:
identifying a plurality of data sources, wherein at least some of the data sources in the plurality of data sources label a common type of data differently such that a plurality of different labeling schemas are present among the plurality of data sources;
detecting the plurality of different labeling schemas from among the plurality of data sources, wherein said detecting includes detecting which labels are used by each data source in the plurality of data sources to label said each data source's corresponding data;
compiling, from among the plurality of data sources, a group of labels that are determined to commonly represent a same type of data despite at least some of the labels in the group being formatted differently relative to one another;
generating an IIT that maps the labels in the group to a commonly defined data type such that, despite at least some of the labels in the group being formatted differently relative to one another, the labels in the group are now all extrinsically linked with one another as a result of the labels in the group all being mapped to the commonly defined data type; and
generating a set of queries that are selectably executable against the plurality of data sources, wherein the set of queries are configured to obtain data that is labeled in accordance with the identified labels, and wherein the set of queries are executable in response to selection of the commonly defined data type included in the IIT.

2. The method of claim 1, wherein the IOC is one of a username, an Internet Protocol (IP) address, or a certificate.

3. The method of claim 1, wherein the data sources include one or more of a database, a file, or a folder.

4. The method of claim 1, wherein the method further includes:
in response to the commonly defined data type being selected, triggering execution of the set of queries against the plurality of data sources.

5. The method of claim 1, wherein the method further includes:
compiling, from among the plurality of data sources, a second group of labels that are determined to commonly represent a second same type of data; and
causing the IIT to map the labels in the second group to a second commonly defined data type.

6. The method of claim 1, wherein the set of queries are executed with enhanced permissions to access the plurality of data sources.

7. The method of claim 1, wherein the set of queries are generated in an offline mode.

8. The method of claim 1, wherein different execution priorities are given to queries in the set of queries such that some of the queries are executed at different times.

9. The method of claim 1, wherein the IIT is modified to include additional mappings between additional commonly defined data types and other groupings of labels.

10. The method of claim 1, wherein results from queries that yield non-zero row counts are ingested for analysis while results from queries that yield zero row counts are not ingested.

11. A method for analyzing results obtained from executing a set of queries against a plurality of data sources in an attempt to identify an indicator of compromise (IOC), said method comprising:
receiving query results that are generated as a result of a set of queries being executed against a plurality of data sources;
analyzing the query results to identify a network of relationships linking a user to a particular IOC, wherein the user is a suspected attacker against one or more data sources in the plurality of data sources;
based on the identified network of relationships linking the user to the particular IOC, triggering generation of a new set of queries for execution against the plurality of data sources, wherein the new set of queries are designed in an attempt to identify additional points of contact the user had with regard to the plurality of data sources; and
analyzing new query results that are generated as a result of the new set of queries being executed against the plurality of data sources.

12. The method of claim 11, wherein analyzing the new query results includes performing a backtracking operation in which the new query results are excluded from subsequent analysis operations as a result of a determination that the new query results are not relevant.

13. The method of claim 11, wherein the new set of queries are generated in response to consulting a identifier index table (IIT), and wherein the IIT maps different labels that are used by different data sources in the plurality of data sources and that commonly represent a same type of data despite at least some of the different labels being formatted differently relative to one another.

14. The method of claim 11, wherein identifying the network of relationships linking the user to the particular IOC includes identifying related terms used to identify the user.

15. The method of claim 14, wherein the related terms are normalized to identify the user.

16. The method of claim 11, wherein identifying the network of relationships linking the user to the particular IOC includes identifying a certificate and pivoting from the certificate to a username used by the user.

17. The method of claim 11, wherein a relationship, which is included in the network of relationship, is established when two entities appear in a same row of a data source.

18. The method of claim 11, wherein analyzing the query results further includes identifying one or more instances where a user approved that user's own user request.

19. The method of claim 11, wherein analyzing the query results further includes generating time-based correlations.

20. A method for generating an identifier index table (IIT) that maps different labels used among different data sources to a commonly defined data type and for using the IIT to generate a set of queries that are executable based on selection of the commonly defined data type and that are executable against the different data sources to search for an indicator of compromise (IOC) within said different data sources, said method comprising:
identifying a plurality of data sources, wherein at least some of the data sources in the plurality of data sources label a common type of data differently such that a plurality of different labeling schemas are present among the plurality of data sources;
detecting the plurality of different labeling schemas from among the plurality of data sources, wherein said detecting includes detecting which labels are used by each data source in the plurality of data sources to label said each data source's corresponding data;
compiling, from among the plurality of data sources, a group of labels that are determined to commonly represent a same type of data despite at least some of the labels in the group being formatted differently relative to one another;
generating an IIT that maps the labels in the group to a commonly defined data type such that, despite at least some of the labels in the group being formatted differently relative to one another, the labels in the group are now all extrinsically linked with one another as a result of the labels in the group all being mapped to the commonly defined data type;
generating a set of queries that are selectably executable against the plurality of data sources, wherein the set of queries are configured to obtain data that is labeled in accordance with the identified labels, and wherein the set of queries are executable in response to selection of the commonly defined data type included in the IIT;
receiving query results that are generated as a result of the set of queries being executed against the plurality of data sources;
analyzing the query results to identify a network of relationships linking a user to a particular IOC, wherein the user is a suspected attacker against one or more data sources in the plurality of data sources;
based on the identified network of relationships linking the user to the particular IOC, triggering generation of a new set of queries for execution against the plurality of data sources, wherein the new set of queries are designed in an attempt to identify additional points of contact the user had with regard to the plurality of data sources; and
analyzing new query results that are generated as a result of the new set of queries being executed against the plurality of data sources.
